(19) United States
(12) Patent Application Publication
(10) Pub. No.: US 2015/0063426 A1
(43) Pub. Date: Mar. 5, 2015

(54) SYSTEMS AND METHODS FOR PSEUDO-RANDOM CODING

(71) Applicant: NextNav, LLC, Sunnyvale, CA (US)

(72) Inventors: Norman F. Krasner, Redwood CIty, CA (US); Bhaskar Nallapureddy, Santa Clara, CA (US)

(21) Appl. No.: 14/466,826

(22) Filed: Aug. 22, 2014

Related U.S. Application Data
(63) Continuation of application No. 14/011,277, filed on Aug. 27, 2013.

(51) Int. Cl. H04B 1/709; G01S 19/13; H04W 4/02

(52) U.S. Cl. CPC H04B 1/709; H04W 4/025; G01S 19/13
USPC 375/142

(57) ABSTRACT

Systems and methods for improving performance in terrestrial and satellite positioning systems are disclosed. Signal processing systems and methods are described for selecting, from among a set of codes, certain codes having desired autocorrelation and/or cross-correlation properties. Systems and methods for generating, encoding, transmitting, and receiving signals using the selected codes are also described.

### FIELD

This disclosure relates generally to positioning systems. More specifically, but not exclusively, this disclosure relates to systems, methods, computer-readable media and other means that generate coded signals at multiple transmitters, transmit the coded signals to a receiver, and/or process the coded signals after they are received at a receiver in order to estimate the receiver's position.

### BACKGROUND

Quickly and accurately estimating locations of things (e.g. a receiver) in a geographic area can be used to speed up emergency response times, track business assets, and link consumers to nearby businesses. Various techniques are used to estimate the position of the receiver, including a technique called trilateration, which is the process of using geometry to estimate the position of a receiver using distances traveled by different signals that are transmitted from geographically-distributed transmitters and later received by the receiver.

In many cases, the signals transmitted by geographically-distributed transmitters are received by the receiver at or near the same time, which makes it necessary for the receiver to distinguish each signal from other signals in order to determine the travel time of that signal for use during trilateration processing. Each transmitter may code its signal so the receiver can effectively identify that signal from other signals. As described later herein, however, designing and operating systems and methods for selecting different codes at various transmitters requires careful consideration of various issues.

### SUMMARY

Various embodiments, but not necessarily all embodiments, described in this disclosure relate generally to systems, methods, and machine-readable media for generating coded signals at multiple transmitters, transmitting the coded signals to a receiver, and/or processing the coded signals after they are received at a receiver in order to estimate the receiver's position.

According to certain aspects, systems, methods and machine-readable media may: identify a set of codes, wherein a magnitude of an autocorrelation function of each member of the set of codes, within a specified zonal region adjacent to a peak of the autocorrelation function, is equal to or less than a first prescribed value; and identify a subset of codes, from among two or more subsets of codes in the set of codes, that optimizes a performance criterion, wherein the performance criterion is associated with a relationship between members of the subset.

According to other aspects, systems, methods and machine-readable media may: identify a first code from a subset of codes within a set of codes, wherein a magnitude of an autocorrelation function of each member of the set of codes, within a zonal region adjacent to a peak of the autocorrelation function, meets a threshold condition, and wherein the subset optimizes a performance criterion between its members compared to other subsets of the set.

According to other aspects, systems, methods and machine-readable media may: receive, at a receiver, a first positioning signal that is encoded at least in part with a first code selected from a first subset of a set of codes, wherein the set of codes are characterized by having a magnitude of an autocorrelation function of each member of the set, within a specified zonal region adjacent to a peak of the autocorrelation function, equal to or less than a first prescribed value, and wherein the first subset is selected from among a group of subsets to optimize a performance criterion in comparison to the other subsets of the group, wherein the performance criterion is associated with a relationship between members of the first subset; receive, at the receiver, a second positioning signal that is encoded at least in part with a second code from the first subset of codes; and determine, based at least in part on the first and second positioning signals, information used to estimate the receiver's position.

The details of one or more embodiments of the invention are set forth in the accompanying drawings and the description below.

### BRIEF DESCRIPTION OF THE DRAWINGS

FIG. 1 illustrates an example positioning system;

FIG. 2 illustrates an example receiver;

FIG. 3 illustrates an example transmitter;

FIG. 4 illustrates an example set of PRN codes;

FIG. 5 illustrates an example cross-correlation rejection between selected codes;

FIG. 6 illustrates details of an example method for generating a set of codes;

FIG. 7 illustrates an example method for transmitting signals;

FIG. 8 illustrates an example method for receiving signals and extracting information from the received signals to be used to estimate a position of a receiver;

FIG. 9 illustrates an example method for receiving signals from two or more transmitters, and for extracting information from the received signals to be used to estimate a position of a receiver;

FIG. 10 illustrates an example method for generating a set of codes in association with frequency offset multiplexing (FOM);

FIG. 11 illustrates an example method of transmission of signals from transmitters in a WAPS system using FOM;

FIG. 12 illustrates an example method of receiving signals from transmitters in association with FOM, and for extracting information from the received signals to be used to estimate a position of a receiver; and

FIG. 13 illustrates an example method for receiving signals from two or more transmitters in association with FOM, and for extracting information from the received signals to be used to estimate a position of a receiver.

### DETAILED DESCRIPTION OF EMBODIMENTS

This disclosure relates generally to positioning systems and methods for estimating a position (or “location”) of things like receivers that reside within the positioning systems. More specifically, but not exclusively, the disclosure relates to systems, methods and computer-readable media for coding signals at different transmitters, transmitting those coded signals to one or more receivers, and/or processing the coded signals after they are received in order to estimate a position of a particular receiver. It is noted that, in the context of this disclosure, a positioning system may be a system that localizes a receiver's position. Various coordinates may be used to represent the receiver's position, including latitude, longitude, and altitude (LLA) coordinates, dimensional coordinates (x, y, z), angular coordinates, polar coordinates, and the like. One of ordinary skill in the art will understand alternative representations of a receiver's position.

In the following description, numerous specific details may be introduced to provide a thorough understanding of and enabling description for various embodiments of systems and methods. It is noted that well-known structures or operations are not necessarily shown or fully described in order to avoid obscuring certain aspects of each embodiments. One of ordinary skill in the art, however, will recognize that each embodiment can be practiced without one or more of the specific details, with details from other embodiments, or with omitted details that are known in the art.

In the following description, emphasis is placed upon selection of codes (also referred to as “pseudorandom sequences”), use of the codes to transmit signals, and use of the codes to process received signals.

### Example Systems

In various positioning systems, like the Wide Area Positioning Systems (WAPS) described in, for example, U.S. patent application Ser. No. 13/535,128, entitled WIDE AREA POSITIONING SYSTEMS AND METHODS, filed Jun. 27, 2012, the content of which is incorporated by reference herein, times of arrival of positioning signals sent from multiple transmitters are measured at a corresponding receiver to determine distances to known transmitter locations, which are used to estimate a position of a receiver during a process commonly referred to as trilateration.

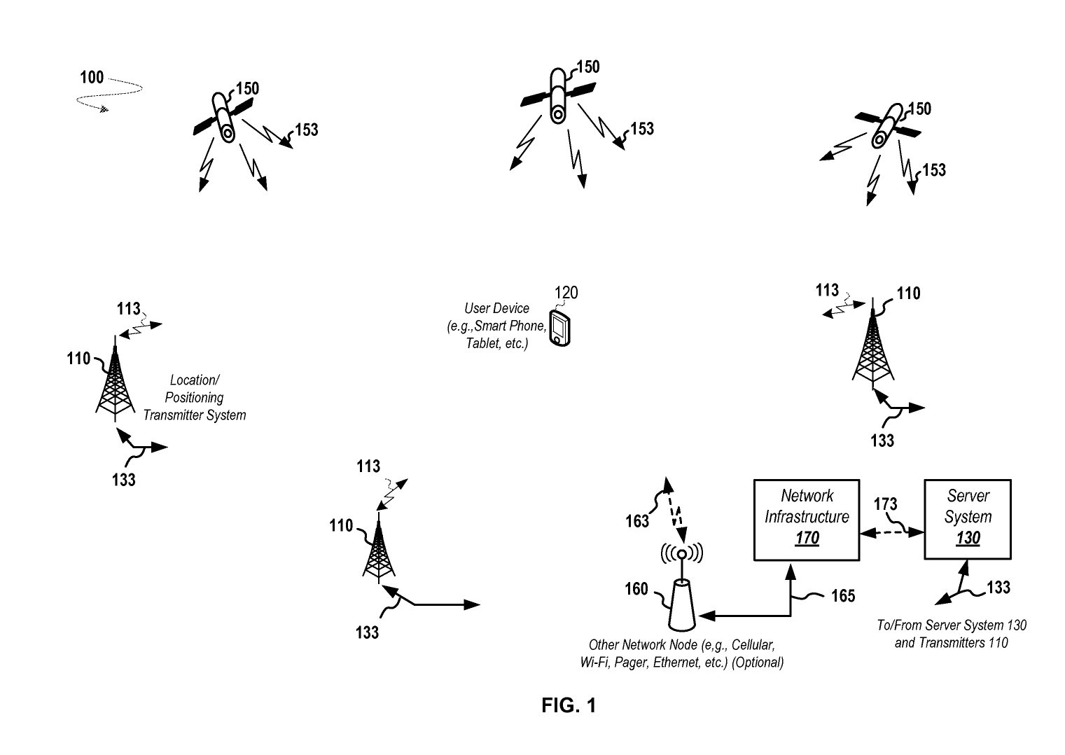

FIG. 1 illustrates one example of a positioning system 100, on which various embodiments may be implemented. The system 100 is shown to include several different systems as described below, including a transmitter system 110, a receiver system 120, a server system 130, a satellite system 150 and other systems. Communication among these systems may be achieved by wired and wireless technologies known or developed later in the art.

As shown, the system 100 includes multiple terrestrial transmitters 110 that broadcast synchronized positioning signals, via communication links 113, to the receiver 120 (also denoted herein as “user device”). Distances between the receiver 120 and each of the transmitters 110 are estimated in order to estimate the position of the receiver 120. Estimation of the receiver's position may take place at the receiver 120, the server system 130, or another system.

A single receiver 120 is shown in FIG. 1 for simplicity; however, a typical system will be configured to support many receivers 120 within a defined coverage area. In a large scale system different receivers 120 separated by large enough distances will typically be served by distinct sets of the transmitters 110, and such sets may be totally disjoint if the distances are large, or may have some of the transmitters 110 in common.

While most embodiments described herein relate to functionality of the transmitters 110, it is noted that the satellite system 150 may be used with the transmitters 110, or may take the place of the transmitters 110, to implement similar functionality to that disclosed in relation to those embodiments.

The transmitters 110 need not be restricted to only transmitting information, but may also have receiving functionality. For example, the transmitters 110 may receive synchronization information from other systems like the server system 130. In one embodiment, the transmitters 110 are configured to operate in an exclusively licensed or shared licensed radio spectrum; however, some embodiments may be implemented to provide signaling in unlicensed shared spectrum. The transmitters 110 may transmit signaling in these various radio bands using signaling as is described in U.S. patent application Ser. No. 13/535,128, which is incorporated by reference herein. This signaling may be in the form of a proprietary signal configured to provide specific data in a defined format that is advantageous for estimating a receiver's position. For example, the signaling may be structured to be particularly advantageous for operation in obstructed environments, such as where traditional satellite position signaling is attenuated and/or impacted by reflections, multipath, and the like. In addition, the signaling may be configured to provide fast acquisition and position determination times to allow for quick location determination upon device power-on or location activation, reduced power consumption, and/or to provide other advantages.

The receiver 120 may, by way of example, refer to part or all of a mobile device that is capable of receiving signaling, processing signaling, transmitting signaling, tracking signaling, computing position estimates, and/or carrying out various other computing operations. One example of signaling includes signals from the transmitters 110. It is noted that the receiver 120 may receive multiple delayed “copies” or “versions” or ‘components” of a single transmitted signal, such as a signal 113 from one of the transmitters 110 of FIG. 1. The receiver 120 often receives multiple signals corresponding to a multiplicity of multipath components as well as a direct path signal component from each of the transmitters 110. The delayed copies may be due to reflective surfaces in the operating environment, such as buildings or other structures, terrain, and the like. A fundamental limitation on performance in many positioning systems is often imposed by received multipath signals, which may be amplitude attenuated and/or phase shifted relative to a corresponding direct path signal. These delayed signals may distort the estimated time of arrival at the receiver 120, which leads to distance estimation errors and erroneous trilateration results. This can be extremely problematic in applications such as first-response during emergencies and the like. Systems and methods disclosed herein mitigate these issues.

Of course, the receiver 120 may receive other signaling, including signals from the satellite system 150 (e.g. a GNSS system) via satellite communication links 153, and other network signaling form a network node 160 (e.g. cellular, Wi-Fi, Wi-Max, pager, Bluetooth, Ethernet, and/or other nodes) via communication link 163. While signaling shown in FIG. 1 is shown as being provided from particular systems, it is noted that the signaling may be passed through intermediate systems (not shown).

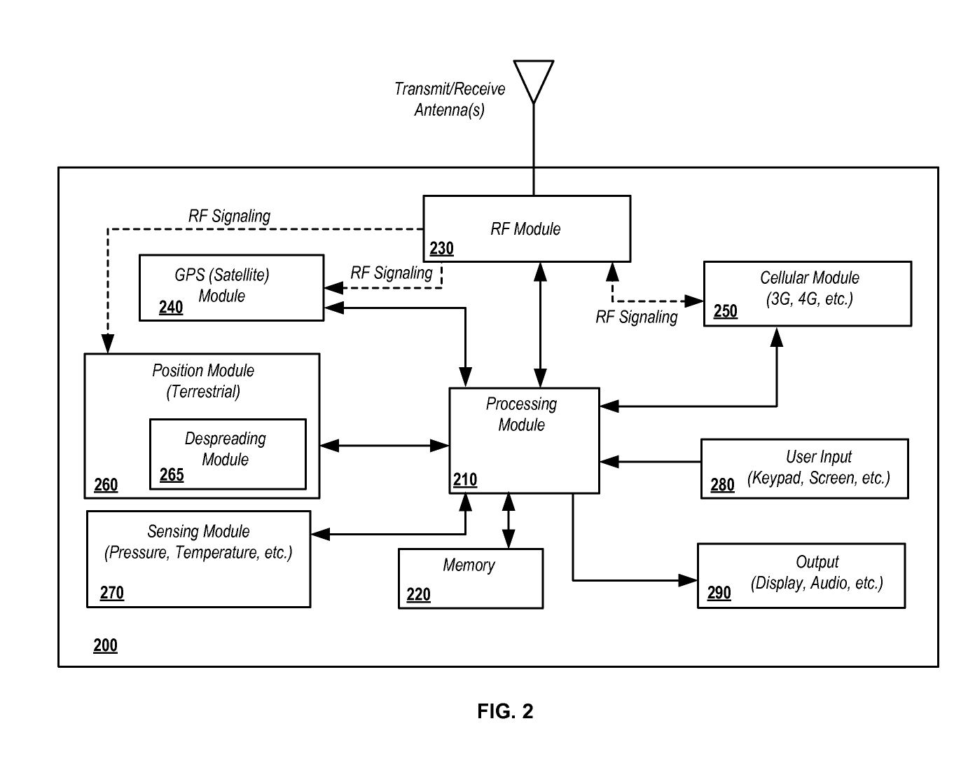

The receiver 120 may be embodied by various devices, including a phone, a tablet, a dedicated location device (e.g. like an asset tracker), a radio receiver, or other electronic device. In some embodiments, the receivers 120 include a location computation engine to determine positioning information from signals received from the transmitters 110, the satellite systems 150, and/or other systems like the network node 160. Depending on the embodiment, the receiver 120 may have receiving and/or transmitting functionality, both in wireless and wired configurations. In some embodiments the receivers 120 transmit information to the transmitters 110. FIG. 2, described elsewhere herein, illustrates an example receiver architecture.

The system 100 may further include a server system 130 in communication with various other systems, such as the transmitters 110 (via communication links 133), network infrastructure 170 (e.g. the Internet, cellular networks, wide or local area networks), and/or other networks. The server system 130 may include various system-related information and components, such as an index of the transmitters 110, a billing interface, one or more encryption algorithm processing modules based on one or more proprietary encryption algorithms, a location computation engine module, and/or other processing modules, each of which may facilitate position, motion, and/or position determination of things in the system 100.

The receiver 120 may transmit information (e.g. the receiver's estimated position or measurements extracted from signaling) to the server system 130 or other components via various communication network links (e.g. links 113, 163 or others). For example, in a cellular network, a cellular backhaul link 165 may be used to provide information from the receiver 120 to associated cellular carriers and/or other systems via the network infrastructure 170. This may be used to quickly and accurately locate the position of the receiver 120 during an emergency, or may be used to provide location-based services or other functions from cellular carriers or other user devices and systems.

In at least one embodiment, the transmitters 110 broadcast output signals that carry positioning information and/or other data or information to the receivers 120. The positioning signals may be coordinated so as to be synchronized across all of the transmitters 110. The transmitters 110 may use a disciplined GPS clock or other source for timing synchronization. Signal transmissions may include dedicated communication channel methodologies (e.g. amplitude, time, code, phase and/or frequency modulation and multiplexing methods) to facilitate transmission of data required for trilateration, notification to subscriber/group of subscribers, broadcast of messages, general operation of the transmitters 110, and/or for other purposes such as are described elsewhere herein and/or in the following patent applications, which are incorporated by reference herein: U.S. Utility patent application Ser. No. 13/412,487, entitled WIDE AREA POSITIONING SYSTEMS, filed on Mar. 5, 2012; U.S. Utility patent Ser. No. 12/557,479 (now U.S. Pat. No. 8,130,141), entitled WIDE AREA POSITIONING SYSTEM, filed Sep. 10, 2009; U.S. Utility patent application Ser. No. 13/412,508, entitled WIDE AREA POSITIONING SYSTEM, filed Mar. 5, 2012; U.S. Utility patent application Ser. No. 13/296,067, entitled WIDE AREA POSITIONING SYSTEMS, filed Nov. 14, 2011; Application Serial No. PCT/US12/44452, entitled WIDE AREA POSITIONING SYSTEMS, filed Jun. 28, 2011); U.S. patent application Ser. No. 13/535,626, entitled CODING IN WIDE AREA POSITIONING SYSTEMS, filed Jun. 28, 2012; U.S. patent application Ser. No. 13/536,051, entitled CODING IN WIDE AREA POSITIONING SYSTEM (WAPS), filed Jun. 28, 2012; U.S. patent application Ser. No. 13/565,614, entitled CELL ORGANIZATION AND TRANSMISSION SCHEMES IN A WIDE AREA POSITIONING SYSTEM (WAPS), filed Aug. 2, 2012; U.S. patent application Ser. No. 13/565,732, entitled CELL ORGANIZATION AND TRANSMISSION SCHEMES IN A WIDE AREA POSITIONING SYSTEM, filed Aug. 2, 2012; U.S. patent application Ser. No. 13/565,723, entitled CELL ORGANIZATION AND TRANSMISSION SCHEMES IN A WIDE AREA POSITIONING SYSTEM, filed Aug. 2, 2012; U.S. patent application Ser. No. 13/831,740, entitled SYSTEMS AND METHODS CONFIGURED TO ESTIMATE RECEIVER POSITION USING TIMING DATA ASSOCIATED WITH REFERENCE LOCATIONS IN THREE-DIMENSIONAL SPACE, filed Mar. 14, 2013; and U.S. patent application Ser. No. 13/909,977, entitled SYSTEMS AND METHODS FOR LOCATION POSITIONING of USER DEVICE, filed Jun. 4, 2013. The above applications, publications and patents may be individually or collectively referred to herein as “incorporated reference(s)”, “incorporated application(s)”, “incorporated publication(s)”, “incorporated patent(s)” or otherwise designated.

In a positioning system that uses a time difference of arrival approach for trilateration, positioning information that is typically transmitted from the transmitters 110 (or other beacons) includes one or more of precision timing sequences (or “ranging sequences”) and positioning data, where the positioning data includes the location of transmitters and various timing corrections and other information. In one embodiment, the data may include additional messages or information such as notification/access control messages for a group of subscribers, general broadcast messages, and/or other data or information related to system operation, users, interfaces with other networks, and other system functions. The positioning data may be provided in a number of ways. For example, the positioning data may be modulated onto a coded timing sequence, added or overlaid over the timing sequence, and/or concatenated with the timing sequence.

Data transmission systems and methods described herein may be used to provide improved positioning information throughput for systems disclosed herein. In particular, the positioning data may be provided by higher order modulation transmitted as a separate portion of information from pseudo-noise (PN) timing or ranging sequences. This may be used to allow improved acquisition speed in systems employing CDMA multiplexing, TDMA multiplexing, frequency offset multiplexing (FOM) or a combination of each of these.

In one embodiment, signals are transmitted from the transmitters 110 using coded modulation called spread spectrum modulation or pseudo-noise (PN) modulation to achieve wide bandwidth. Under these embodiments, the receiver 120 includes one or more modules to receive the transmitted signals and process those signals (e.g. using a despreading circuit, such as a matched filter or a series of correlators). A waveform, which ideally has a strong peak surrounded by lower level energy, is produced, where the time of arrival of the peak represents the time of arrival of a received signal. Performing operations like this on a multiplicity of signals from a multiplicity of the transmitters 110, whose locations are accurately known, allows for the determination of the receiver's location. Various additional details related to signal generation in the transmitter 110, along with received signal processing in the receiver 120, are described elsewhere herein.

In one embodiment, the transmitters 110 use binary coded (bi-phase) modulation as the spreading method. Signals from the transmitters 110 may include two specific types of information: (1) a high speed ranging signal, and (2) position location data such as transmitter ID, transmitter position, time of day, health, environmental conditions such as pressure data, and the like. The transmitters 110 may transmit positioning information by modulating a high speed binary pseudorandom ranging signal with a lower rate information source.

The disclosures herein and in the incorporated references describe methods and systems that use a pseudorandom ranging signal and a modulating information signal, both of which may utilize higher order modulations, such as quaternary or octonary modulation. In one embodiment, the ranging signal is binary phase modulated, and positioning information is provided in a separate signal using higher order modulation.

By way of example, time division multiplexing systems use transmission slots that each comprise a pseudorandom ranging signal followed by various types of location data. These systems also include a synchronization (or “sync”) signal, which may be deleted if the pseudorandom ranging signal is used also as the sync signal. However, the location data of these conventional systems is normally binary, which limits throughput. To address these limitations, a binary or quaternary pseudorandom signal may be transmitted in a particular slot followed by a higher order modulated data signal. For example, in a given slot, one or more positioning information symbols may be transmitted using differential 16-phase modulation in order to transmit four bits of information per slot. This can achieve a four-fold throughput improvement versus the one bit typically transmitted when binary phase modulation is imposed upon a pseudorandom carrier. In certain, but not necessarily all, implementations of this example, adequate signal strength is assumed to be present at the receiver. Other types of modulation of positioning information may also be utilized, such as 16 QAM, and the like. In addition, certain error control modulation methods may be used for the higher level modulation, such as the use of Trellis codes. These error control modulation methods generally reduce error rates.

### Example Receiver Systems

Turning to FIG. 2, an example of a receiver 200 is illustrated. The receiver 200 may form part or all of the receiver 120 of FIG. 1. For example, the receiver 200 may be included in a smart phone, tablet, or other device at which transmitted positioning signals may be received and processed to determine positioning information.

As shown, the receiver 200 may include one or more GPS modules 240 for receiving GPS signals (e.g. via an RF module 230), and for determining positioning information and/or other data, such as timing data, dilution of precision (DOP) data, or other data or information as may be provided from a GPS or other positioning system. The GPS module 240 may provide the determined information to a processing module 210 and/or other modules of the receiver 200.

The receiver 200 may also include one or more cellular modules 250 for sending and receiving data or information via a cellular or other data communications system. Alternatively, or in addition, the receiver 200 may include other communications modules (not shown) for sending and/or receiving data via other wired or wireless communications networks, such as Wi-Fi, Wi-Max, Bluetooth, USB, Ethernet, or other data communication networks.

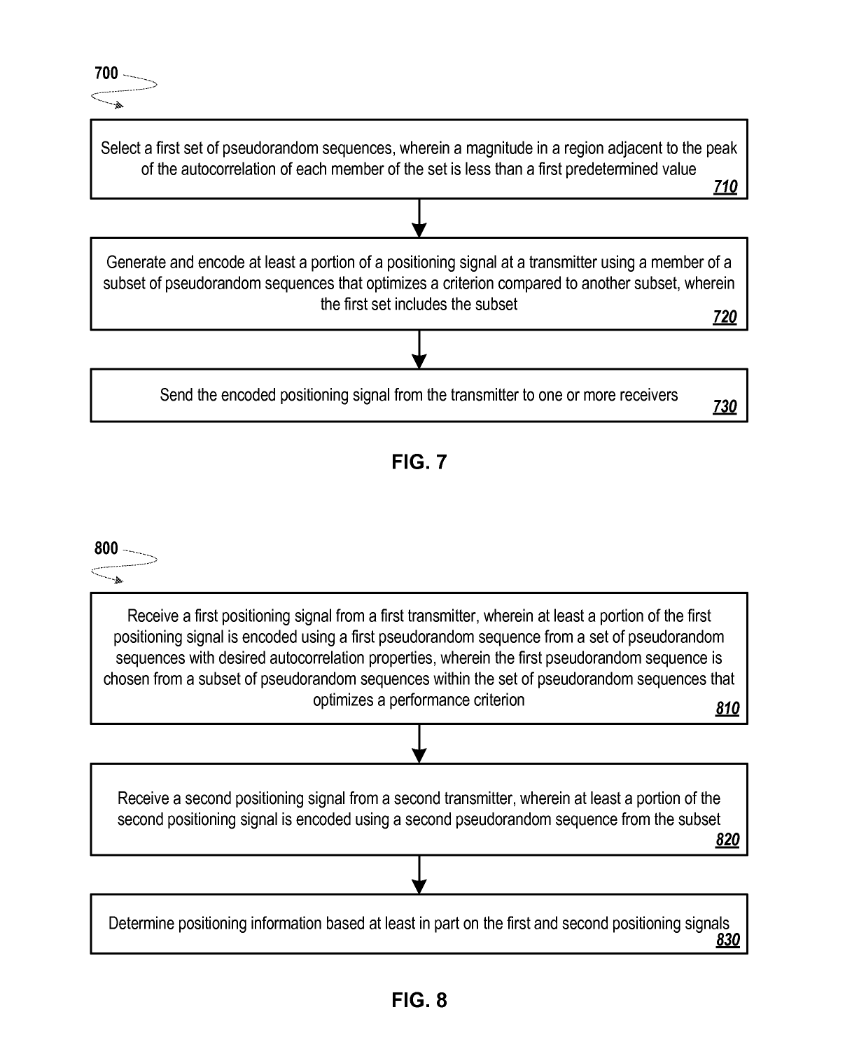

The receiver 200 may include one or more position modules 260 for receiving signals from terrestrial transmitters, such as the transmitters 110 of FIG. 1, and for processing the signals to extract positioning information (e.g. time of arrival, time of transmission) as described elsewhere herein. One example of signal processing includes multipath signal processing as described subsequently with respect to FIG. 7 through FIG. 13. The position module 260 may be integrated with and/or may share resources such as antennas, RF circuitry, and the like with other modules like the GPS module 240 and the cellular module 250. For example, the position module 260 and the GPS module 240 may share some or all radio front end (RFE) components and/or processing elements.

The processing module 210 may be integrated with and/or share resources with the position module 260 and/or other modules to determine positioning information and/or perform other processing functions as described herein. A despreading module 265 may be incorporated in the position module 260 or another module like the processing module 210, or may be a standalone module.

One or more memories 220 may be linked to the processing module 210 to provide storage and retrieval of data and/or to provide storage and retrieval of instructions for execution in the processing module 210. For example, the instructions may be used to perform the methods described elsewhere herein, such as those methods associated with signal and multipath signal processing, determining positioning information or other information, or other processing functions.

The receiver 200 may further include one or more environmental sensing modules 270 for sensing or determining various conditions, such as, pressure, temperature, motion or other measurable conditions at the location of the receiver 200.

The receiver 200 may further include various user interface modules like a user input module 280, which may be in the form of a keypad, touchscreen display, mouse, or other user interface element. Audio and/or video data or information may be provided on an output module 290, such as in the form of one or more speakers or other audio transducers, one or more visual displays, and/or other user I/O elements.

Although not shown, the receiver 200 may include a matched filter that is used to process a received spread spectrum signal. The matched filter may be implemented in the processing module 210, the position module 260, the despreading module 265, or another module. A set of correlators may be used instead of a matched filter to provide information similar to that provided by a matched filter. One of ordinary skill in the art will appreciate alternative approaches to achieve the same or similar results as a matched filter or a correlator.

### Example Transmitter Systems

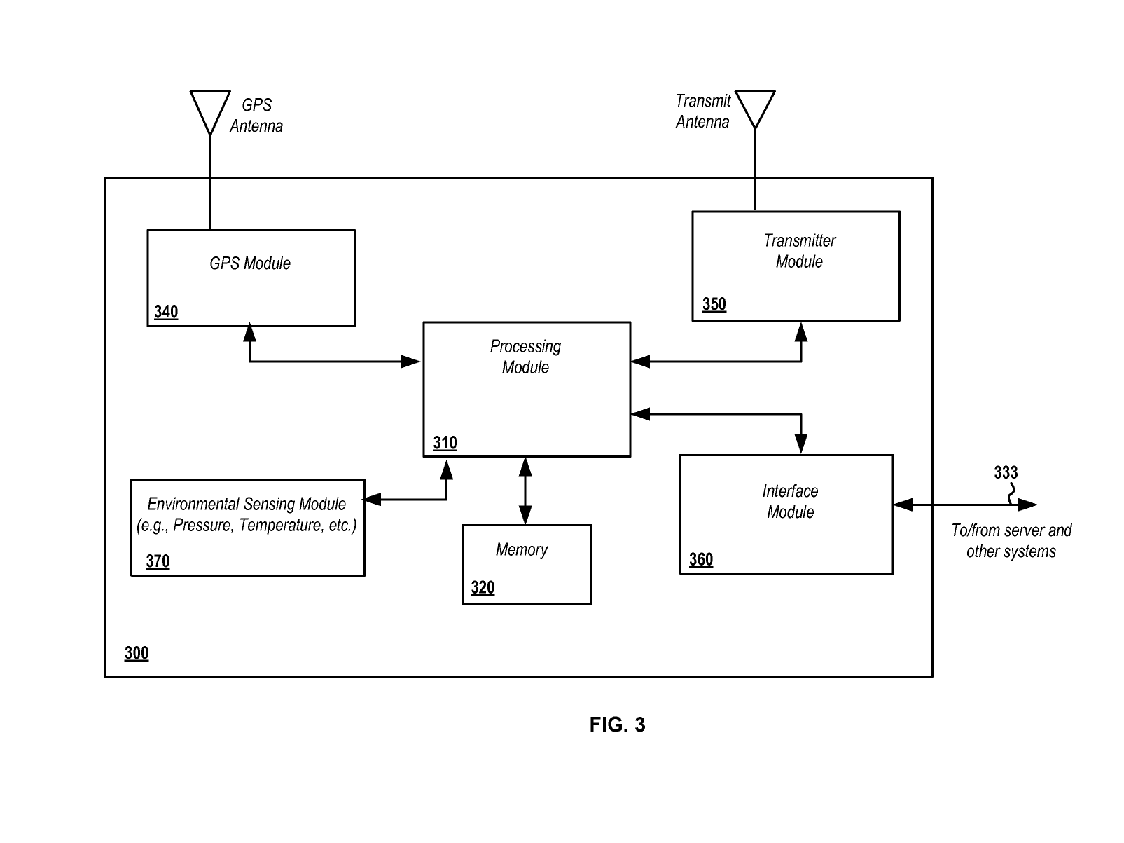

FIG. 3 illustrates an embodiment of a transmitter system 300 from which positioning signals may be transmitted. The transmitter 300 may correspond with the transmitters 110 of FIG. 1. It is noted that the transmitter 300 includes various modules for performing signal generation, transmission, reception and/or processing; however, in other embodiments, these modules may be combined and/or organized differently to provide similar or equivalent operations.

As shown in FIG. 3, the transmitter 300 may include one or more GPS modules 340 for receiving GPS signals, and processing those GPS signals to determine information like timing data, dilution of precision (DOP) data, or other data. The determined information may be provided to a processor module 310. GPS or other timing signals may be used for precision timing operations within the transmitter 300 and/or for timing correction across the a network like the system 100 of FIG. 1.

The transmitter 300 may also include one or more transmitter modules 350 for generating and sending transmitter output signals to receivers. The transmitter module 350 may also include various elements as are known or developed in the art for providing output signals to a transmit antenna, such as analog or digital logic and power circuitry, signal processing circuitry, tuning circuitry, buffer and power amplifiers, and the like. Signal processing for generating the output signals may be performed in the processing module 310 which, in some embodiments, may be integrated with the transmitter module 350 or, in other embodiments, may be a standalone module for performing multiple signal processing and/or other operations.

One or more memories 320 may be coupled with the processing module 310 to provide storage and retrieval of data, and/or to provide storage and retrieval of instructions for execution in the processing module 310. For example, the instructions may be instructions for performing the various methods described herein, such as methods used for generating signals, codes, coded signals, or other information.

The transmitter 300 may further include one or more environmental sensing modules 370 for sensing or determining conditions associated with the transmitter 300, such as, for example, local pressure, temperature, or other conditions. In one embodiment, pressure information may be generated by the environmental sensing module 370 and provided to the processing module 310 for integration with other data in transmitter output signals as described elsewhere herein.

One or more interface modules 360 may also be included in the transmitter 300 to provide an interface between the transmitter 300 and the server system 130 of FIG. 1 or to other systems. In some embodiments, the server system 130 of FIG. 1 sends information to the transmitters 110 via the interface module 360.

Attention is now turned to different approaches for generating signals, selecting codes (or “pseudorandom sequences”), coding the signals with the codes, transmitting the coded signals, and/or processing the coded signals after they are received by a receiver.

### Example Approaches

Various embodiments relate to systems and methods that use codes (or “pseudorandom sequences”) for various reasons, such as mitigating the effects of multipath. Such systems and methods may use transmitters that generate and transmit coded signals, and receivers that process the coded signals, as discussed in further detail below.

In one or more embodiments, codes with very good auto- and cross-correlation properties are used. Such codes may be used in multiple access systems employing CDMA multiplexing, TDMA multiplexing, frequency offset multiplexing (FOM) or a combination of CDMA, TDMA, and FOM. The different possible combinations are referred to as “hybrid” multiplexing.

As noted previously, a positioning system includes multiple beacons that broadcast positioning signals to receivers. Examples of such beacons include the transmitters 110 and/or satellites 150 of FIG. 1. Such positioning systems are often impacted by multipath in urban environments. Under circumstances where multipath is present, the receiver may receive a multiplicity of signals from one or more of the beacons, where the multiplicity of signals correspond to a multiplicity of direct and multipath signals. The range of delays associated with the multipath signals, also referred to as the delay spread, is typically constrained by geometric situations in the particular operating environment. For example, a delay spread of 1 microsecond may correspond to a maximum differential path length of 300 meters, and a spread of 5 microseconds may correspond to 1500 meters.

In one embodiment, for example, a system transmits coded modulated signals in the form of spread spectrum modulation or pseudo noise (PN) modulation to achieve wide bandwidth. A receiver processes such signals with a despreading circuit. Such a receiver produces a waveform which ideally has a strong peak surrounded by lower level energy. The time of arrival of the peak represents the time of arrival of the measured signal at the receiver. Performing this operation on measured signals from several beacons (e.g., four beacons), whose locations are accurately known, allows determination of the receiver's location via trilateration.

If multipath is present, a matched filter processes the received spread spectrum signals, and its output produces a series of possibly overlapping sharp pulses of varying amplitudes, delays and phases. The signals are processed to estimate the time of arrival of the earliest pulse. A variety of algorithms may be used for this purpose, such as leading edge location algorithms, MUSIC algorithm, minimum mean square estimation algorithms, and the like.

One problem that arises, however, is that the energy surrounding the peak typically contains a series of subsidiary peaks, or “side lobes.” The structure of such side lobes in a preferred situation (e.g. no to low noise or multipath) is described by a function called the “autocorrelation function”.

In multipath environments, these subsidiary peaks may be confused with a weak early signal arrival. For C/A civilian codes in a GPS system, for example, certain binary codes called “Gold Codes” are often used. These codes are typically of a frame length of 1023 symbols or “chips”. A matched filter receiving such a Gold code produces a set of side lobes of amplitude −65/1023 times the peak amplitude, 63/1023 times the peak amplitude and −1/1023 times the peak amplitude. Thus, the magnitude of the largest side lobe is approximately 0.06 times the peak amplitude, or −24 dB. Typically these large amplitude side lobes may be adjacent to or close to the peak amplitude of the autocorrelation function. In a severe multipath environment (e.g. in urban canyons of cities) one seeks much better side lobe rejection, at least within a range about the autocorrelation function peak. U.S. patent application Ser. No. 13/535,626, entitled CODING IN WIDE AREA POSITIONING SYSTEMS, filed Jun. 28, 2012, and U.S. patent application Ser. No. 13/536,051, entitled CODING IN WIDE AREA POSITIONING SYSTEM (WAPS), filed Jun. 28, 2012, which are incorporated herein by reference, provide methodologies for choosing codes with very good side lobe rejection. Although various algorithms (such as the MUSIC algorithm) can in principle deal with side lobes of varying levels, simulations have indicated that, in real world situations, such side lobes are often confused with true early signals, or they hide early signals. This is particularly true when the processed signal-to-noise ratios are low.

It is noted that, the terms autocorrelation and cross-correlation may refer to circular autocorrelation and circular cross-correlation. This is appropriate since in typical system implementations, repeated sequences are used to thereby allow the correlation operations to appear to be approximately circular. In some cases, attention may be placed upon restricted ranges of code offsets, in which case even if the codes do not repeat, the autocorrelations and cross-correlations over restricted ranges may be approximated as those of a circular variety.

Under many circumstances, multiple transmitters are transmitting signals simultaneously, and/or transmitted signals are received concurrently by a receiver whose position is to be determined. It is necessary for such a receiver to distinguish such signals from one another in order to determine the times of arrivals of the individual signals in support of trilateration processing. In order to accomplish this, at least two approaches may be utilized: (1) choose codes that are used by different transmitters with good cross-correlation properties and (2) utilize signal processing and filtering methods to further reduce the cross-correlations. Consequently, approach (1) requires having sets of codes whose members have excellent autocorrelation side lobe properties (e.g. at least over a limited range about the location of the autocorrelation peak), and the cross-correlation rejection between different members should be low. Approach (2) includes the use of an additional multiplexing method, termed “Frequency Offset Multiplexing (FOM),” as described in U.S. patent application Ser. No. 13/565,614, entitled CELL ORGANIZATION AND TRANSMISSION SCHEMES IN A WIDE AREA POSITIONING SYSTEM, filed Aug. 2, 2012, U.S. patent application Ser. No. 13/565,732, entitled CELL ORGANIZATION AND TRANSMISSION SCHEMES IN A WIDE AREA POSITIONING SYSTEM, filed Aug. 2, 2012, and U.S. patent application Ser. No. 13/565,723, entitled CELL ORGANIZATION AND TRANSMISSION SCHEMES IN A WIDE AREA POSITIONING SYSTEM, filed Aug. 2, 2012, which are incorporated herein by reference. In FOM, different transmitted signals may utilize slightly different carrier frequencies. By integrating such signals over a long interval—e.g. an interval equal to a multiplicity of PN frame periods—a receiver may achieve significant cross-correlation rejection, particularly if the multiplicity is chosen in a special manner related to the frequency offsets between carriers. The carrier frequencies of FOM are typically chosen to be a in a set of frequencies that are offset from a base frequency. The offset set is often formed as a multiple of a minimum offset size.

In approach (2), the carrier frequencies of differing, but typically neighboring, transmitters are chosen to be slightly offset from one another—e.g. typically by values less than 1%. The transmitting signals include a repetition of a code. The receiver may integrate over a multiplicity of such repetitions, i.e. a multiplicity of frames, and it may thereby achieve very large additional rejection of other simultaneously received signals having different frequency offsets.

By properly choosing the frequency offset parameters and the number of frames integrated, the receiver may eliminate the cross interference from the other simultaneously transmitted or concurrently received signals. The effectiveness of this approach is limited however, in the presence of Doppler that is induced by motion of the receiver. Nevertheless, approach (2) in most cases provides significant improvement over use of approach (1) alone.

Consequently, for an embodiment of a system incorporating CDMA and FOM, it is desirable that a set of codes be chosen in view of the following objectives:
(i) each code should have preferred autocorrelation side lobe properties—e.g. at least over a limited range about the location of the autocorrelation peak; and
(ii) each pair of different codes should have good cross-correlation properties for all possible frequency offset differences.
   In the evaluation of the second objective (ii), the cross-correlation may be performed over an interval equal to the code period.

In order to meet the above objectives, the following procedures may be used in at least one embodiment:
(i) choose a large set of codes, each of which has preferred autocorrelation properties at least within a zonal region about the autocorrelation peak location; and
(ii) from the chosen set of codes, examine subsets of these codes to determine a subset such that all pairs of different code in the subset have preferred cross-correlation properties, either for all pairs of members (when FOM is not used) or for all pairs of members over all possible frequency offset differences (when FOM is used).

References to codes with different frequency offsets may refer to signals or waveforms that are modulated both with coded modulation as well as having their carrier frequencies chosen according to a set of frequencies. For brevity, codes with different frequency offsets are identified without explicitly mentioning such a signal or waveform.

In some implementations, such as when FOM is not employed, it is advantageous only to determine a subset such that all pairs of codes have good cross-correlation properties for zero frequency offset. In certain embodiments, a performance criterion is established, which specifies a relationship between members of a chosen subset of codes, and then a final subset of codes is chosen to optimize the criterion. Of course, other criteria could include different measures. For example, if the codes in a set are code phase shifted versions of one another, one might choose as a criterion: identifying a subset of codes, by comparison to a multiplicity of other subsets of codes, that has the largest possible code phase shifts relative to one another.

It is noted that a preferred measure of the quality of the autocorrelation property is the maximum magnitude of the autocorrelation peak, except for that at the peak, within a zonal region about the autocorrelation peak location. In some embodiments, the preferred autocorrelation performance for a set of codes may be more important than the preferred cross-correlation performance of that set or a subset of codes from the set. In one embodiment, this maximum zonal autocorrelation magnitude about the peak is chosen to be less than that of the cross-correlation peak magnitude (e.g. for all codes in a chosen subset) by some value. For example, the autocorrelation magnitude may be equal to or less than one-half (½) of the cross-correlation peak magnitude. Alternatively, the autocorrelation magnitude may be equal to or less than one-tenth ( 1/10) of the cross-correlation magnitude, which may be preferred in some embodiments. A strict autocorrelation condition may be required for situations when there is significant multipath in order to maximize the probability of detecting a direct path signal. It is noted, however, that different threshold conditions are possible with values below 1/10, above ½, and between ½ and 1/10, depending on system requirements.

Less desirable conditions, like where the ratio or difference between the autocorrelation magnitude and the cross-correlation magnitude would not achieve a desired result, may be recognized and used to exclude codes from use, subsets of codes, or sets of codes, instead of identifying desirable codes, subsets or sets. Other quality measures are possible, such as the RMS value of the magnitudes in the zonal region, the second largest magnitude in the zonal region, and the like.

In one embodiment, a criterion of preferred quality of the cross-correlation property is the largest cross-correlation value over all possible code phases and frequency offsets. Other criteria may be used such as only considering the maximum cross-correlation over restricted code phase regions, or the RMS value of the cross-correlation, among others. The quality measures of the autocorrelations and cross-correlations may differ. In many of the examples that follow, the quality measures utilized are the maximum autocorrelation magnitude, except at the peak location, and the maximum cross-correlation magnitude. This is provided for the purposes of clarity. However, as indicated above, many other quality measures may be utilized in substitution for these quality measures.

It is noted that the approaches described herein apply to a variety of possible coded signals. One common spreading method uses binary coded modulation that incorporates binary codes such as Gold Codes, maximal length codes, Kasami Codes, and the like. Other spreading methods utilize quaternary coding sequences in which the two bits per code interval or chip determines one of four carrier phases to be transmitted. There are direct methods of choosing such quaternary sequences, as well as methods in which a combination of two codes, such as Gold Codes are used, as described in U.S. patent application Ser. No. 13/565,614, entitled CELL ORGANIZATION AND TRANSMISSION SCHEMES IN A WIDE AREA POSITIONING SYSTEM, filed Aug. 2, 2012, U.S. patent application Ser. No. 13/565,732, entitled CELL ORGANIZATION AND TRANSMISSION SCHEMES IN A WIDE AREA POSITIONING SYSTEM, filed Aug. 2, 2012, and U.S. patent application Ser. No. 13/565,723, entitled CELL ORGANIZATION AND TRANSMISSION SCHEMES IN A WIDE AREA POSITIONING SYSTEM, filed Aug. 2, 2012, which are incorporated by reference herein.

It is noted that there are other sets of codes which use codes whose elements are defined by digital words with a larger number of bits than two. All of these code types may be utilized in the choosing of the desired code set using the same or a similar procedure to identify code sets having both good autocorrelation and cross-correlation properties.

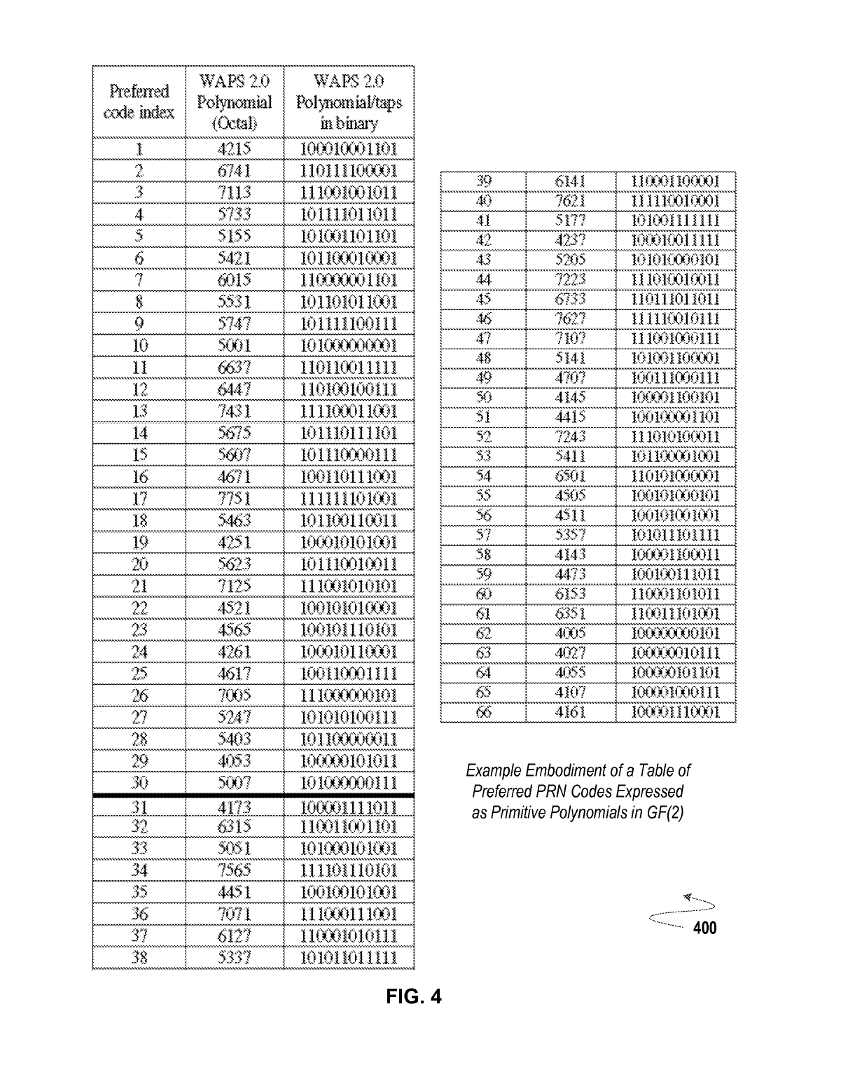

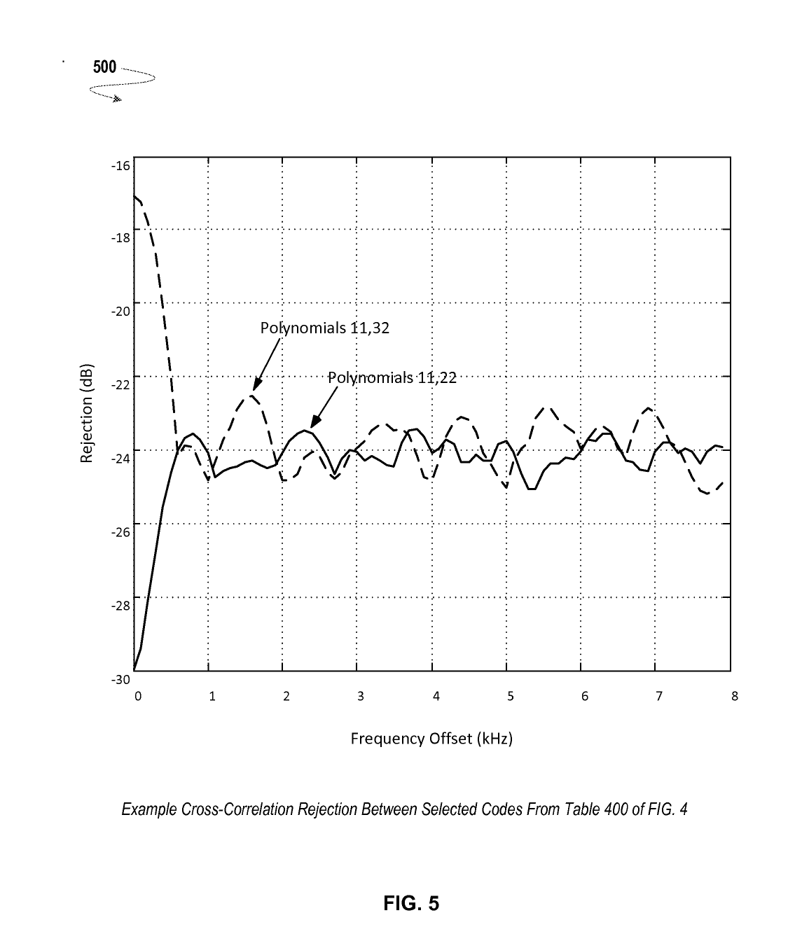

In one embodiment, a subset of binary maximal length sequences may be used. For this embodiment, the sequence length is chosen to be 2047 chips with a chip rate of 2.047 MHz, which produces a PN frame duration of 1 msec. The autocorrelation of a maximal length sequence is nearly ideal in that the side lobes are all of value −1/2047 relative to the peak value. A search was performed on the set of maximal length sequences of length 2047 for good cross-correlation properties between members of a subset of such sequences, across both code phase offset and frequency offset, with the latter in the range 0 to 8 kHz. An ordered list of good PN codes having these properties is provided in table 400 of FIG. 4. In particular, the first 30 codes (i.e. those above the bold horizontal line) had cross-correlation of around −20.9 dB whereas when additional PN codes (i.e. those below the bold line) are included, this increases to around −17 dB. Hence, the choice of the subset of the first 30 codes improves cross-correlation rejection by around 4 dB. Restricting this set to the first 15 codes improves the cross-correlation rejection by another 0.7 dB.

In certain embodiments, the greatest improvement in cross-correlation rejection is for offset frequency differences in the range 0 to 1 kHz. FIG. 5 shows cross-correlation rejection graph 500 for two pairs of codes, the first pair with the polynomials 11 and 22 and the second pair with polynomials 11 and 32. The plotted points show a poor cross-correlation rejection over all code phases for a frequency offset between codes provided along the abscissa. One can see that the second pair has significantly poorer cross-correlation rejection in the range 0 to 1 kHz. Hence choosing codes in accordance with this embodiment produces codes with good autocorrelation performance and, furthermore, has significant advantages for cross-correlation rejection when CDMA and FOM are used, or for the case of CDMA alone. In the above analysis, performance may be analyzed over a continuous range of frequency offsets, even though in practice the offsets are typically chosen to be a small discrete set. However, the presence of Doppler upon the ranging signals can alter the apparent offsets between concurrently received signals, and hence it is necessary to consider a more continuous range of offsets for choosing preferred sets of codes, especially if the receiving platform undergoes significant velocity.

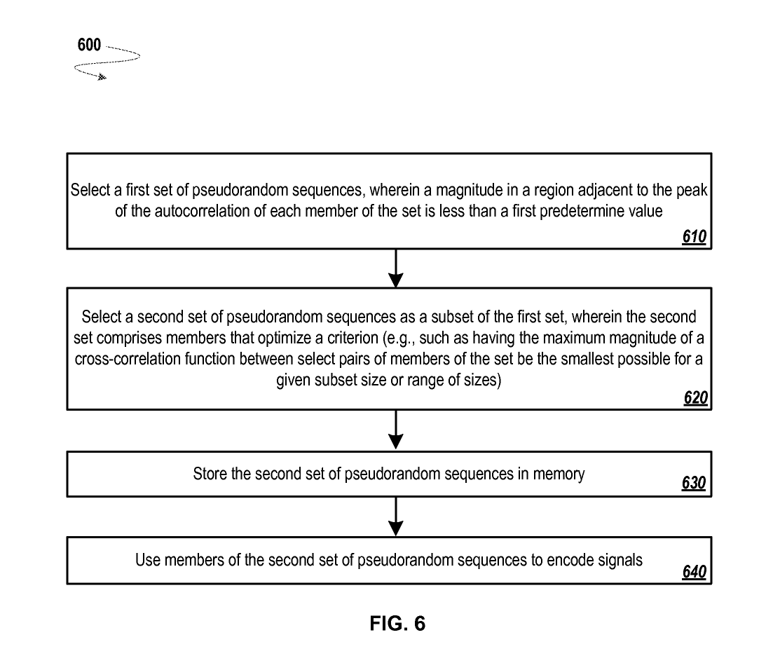

FIG. 6 illustrates a process 600 for identifying a set of codes for use in a positioning system, such as for encoding at least a portion of a positioning signal. At stage 610, a first set of codes may be selected. For example, the first set of codes may be selected such that the magnitude of the autocorrelation function (except at the peak) of each member of the set is less than a predetermined value or threshold. At stage 620, a second set of codes may be selected as a subset of the first set, where the second set of codes optimize a criterion. Subsets of the same or similar size may be analyzed to determine which subset optimizes or achieves preferred results in relation to the criterion, such as having the maximum magnitude of a cross-correlation function between select (e.g., all) pairs of members of the subset be the smallest possible for a given subset size or range of sizes by comparison to other subsets.

Note that for a subset of size M distinct codes, a calculation of the maximum cross-correlation magnitude over all pairs comprises computing the maximum cross-correlation for each of M×(M−1) codes pairs and then finding the maximum of these M×(M−1) maxima. Furthermore, if the subsets are chosen from a set of N distinct codes, then there are N!/[(M!)(N−M)!] possible subsets to choose from. For example if N=20 and M=10, the number of distinct subsets are 184756. Hence, in some cases choosing N extremely large may result in very long computation times for subset optimization.

As an alternative to 620, the second set of codes may be selected as a subset of the first set, where the second set of codes merely achieves (rather than optimizes) a criterion. For example, the criterion to be achieved may be that the maximum magnitude of the cross-correlation function between pairs of members be less than a second predetermined value. This approach of achieving vs. optimizing may be preferable, for example, when the maximization is too laborious to compute, or where some additional constraints may be placed upon the subset of codes. Of course, more than one subset may meet such a criterion, at which point the remaining subsets that meet the criterion may be further evaluated against each other or yet another criterion to select one or more subsets from those subsets for use.

Subset sizes that are similar may be those that fall within a range of sizes (e.g. the size of the sets may be S+/−X, where X may be selected depending on the circumstances, and may be a small percentage like 10% of S).

As previously stated, when optimizing a criterion, for example, the second set may be selected such that it minimizes the maximum magnitude of the cross-correlation function between all pairs of members of the second set relative to other subsets. Selecting the second set in this manner may be used to minimize the value of cross-talk in a receiver during matched filter or correlation processing. At stage 630, the second set of codes may be stored in a memory. By way of example, the memory may be in the server system 130 or in a transmitter 110 of FIG. 1, or another system (not shown). If the memory is in the server system 130, the second set of codes may be provided, at stage 640, to one or more transmitters for use in encoding positioning signals for transmission to a receiver.

FIG. 7 illustrates a process 700 for encoding at least part of a positioning signal using a code from a set of codes. At stage 710, a set of codes are selected. By way of example, all members of the set have a magnitude of their autocorrelation function (except at the peak) less than a predefined value. At stage 720, a positioning signal is generated and at least part of the positioning signal is encoded using a code selected from a subset codes that form part of the set of codes selected at stage 710. By way of example, the subset is selected over another subset because it optimizes a criterion. The selected code may be selected by the transmitter, or provided to the transmitter from another system (e.g. the server system 130 of FIG. 1).

At stage 730, the generated positioning signal may be transmitted from the transmitter and received at one or more receivers. The receivers may look up or generate the selected code for use in demodulating and/or decoding the received positioning signal. In one embodiment, multiple positioning signals are transmitted from different transmitters to the receiver, where each positioning signal is encoded using a different code from the same subset of codes.

FIG. 8 illustrates a process 800 for receiving positioning signals in a system using certain codes. Various devices may receive the positioning signals, including the receiver 120 of FIG. 1, the receiver 200 of FIG. 2, or another system. At stage 810, a first positioning signal is received from a first transmitter. The first positioning signal is encoded at least in part using a first code from a set of codes with desired autocorrelation properties, and further selected from a subset of codes that optimize a performance criterion, such as having magnitudes of cross-correlation functions between all pairs of members of the subset that are less than a predetermined threshold. At stage 820, a second positioning signal, from a second transmitter, is received at the receiver. The second positioning signal is encoded with a second code from the subset of codes. At stage 830, the received first positioning signal and the received second positioning signal are processed to determine positioning information, such as described in the incorporated applications, elsewhere herein or otherwise understood in the art. For criterion relating to minimizing cross-correlation, the crosstalk associated with the first signal will be minimized when processing the second signal. Similarly, the crosstalk associated with the second signal will be minimized when processing the first signal. A similar procedure may be used when receiving three or more signals, as would be understood by one of ordinary skill

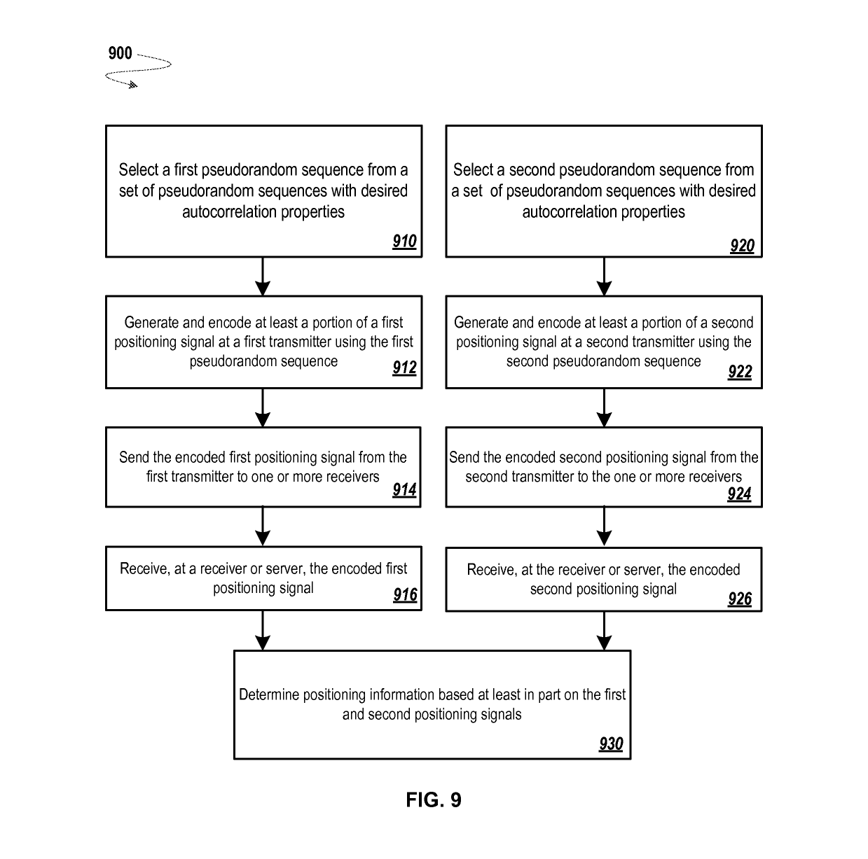

FIG. 9 illustrates details of a process 900 for transmitting positioning signals in a system from two (or more) transmitters, and processing the signals after they are received to determine positioning information at a corresponding receiver. Stages 910 through 914 represent stages performed at a first transmitter, and stages 920-924 represent stages performed at a second transmitter. These stages may be implemented simultaneously in both transmitters. The signals from each are received at a receiver at times that differ primarily due to differences in the ranges from both of the transmitters to the receiver. At stage 910, a first code is selected from a set of codes, where members of the set of codes all have autocorrelation functions (except at the peak) less than a predetermined value. At stage 920, a second code is similarly selected from the set of codes. In one embodiment, the first and second codes are selected from a subset of the set of codes to optimize a performance criterion. The performance criterion may, for example, specify that the subset only include codes that minimize the maximum magnitude of the cross-correlation for a given subset size or range of subset sizes (e.g. subsets that include n+/−k sequences, where k can be any number depending on the circumstances, and preferably no more than a fraction of n).

The first and second codes may be selected well in advance of transmission of positioning signals, and may be generated in a system other than the first and second transmitters, such as the server system 130 of FIG. 1, before being communicated to the first and second transmitters, which may be transmitters such as two of the transmitters 110 of FIG. 1. Alternatively, the first and second codes may be generated in one or both of the first and second transmitters, and/or may be communicated between the first and second transmitters to coordinate which code each transmitter will use.

At stages 912 and 922, first and second positioning signals may be generated at the first and second transmitters, where the first and second positioning signals being encoded at least in part using the corresponding first and second codes, respectively. At stages 914 and 924, the first and second positioning signals may be transmitted from the first and second transmitters, and both signals may be received at a receiver at stages 916 and 926. At stage 930, positioning information (e.g. time of transmission, time of arrival, location of the transmitters, other information) may be determined based at least in part on the first and second positioning signals. This determination may occur at the receiver, or another system (e.g. the server system 130 of FIG. 1). The positioning information may be determined using, for example, signal processing techniques as described herein and in the incorporated applications, or otherwise known by one of ordinary skill in the art.

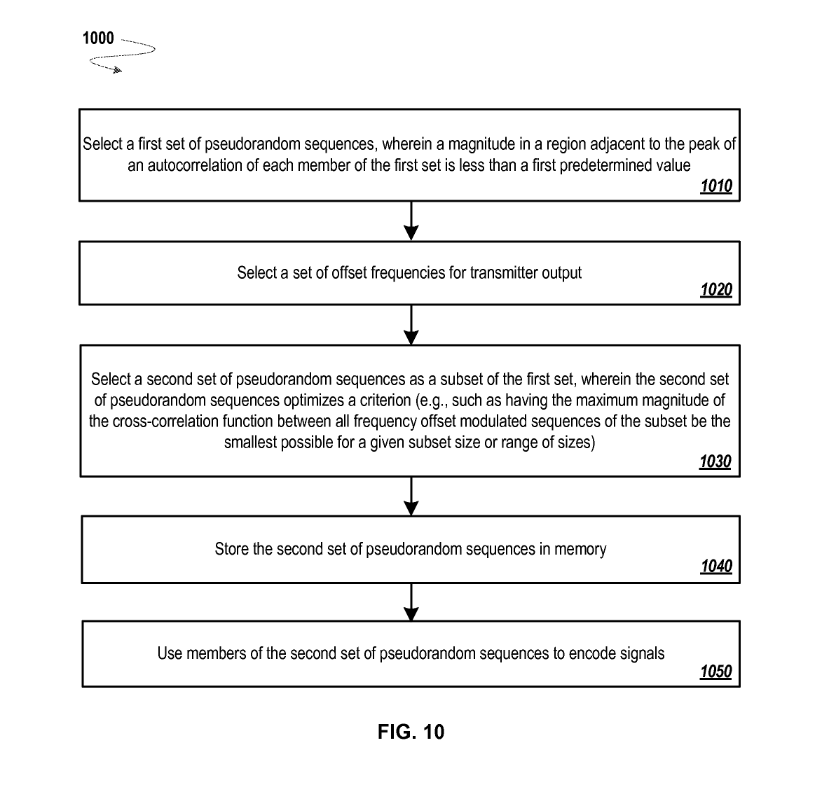

FIG. 10 illustrates a process 1000 for identifying a set of codes for use in a positioning system, such as for encoding at least a portion of a positioning signal. At stage 1010, a first set of codes may be selected. For example, the first set of codes are selected such that the magnitude of the autocorrelation function, in a region adjacent to the peak, of each member of the first set is less than a predetermined value or threshold. At stage 1020 a set of offset frequencies, for use in generating transmitter carrier frequencies offset from a reference (or base) frequency, are selected. At stage 1030, a second set of codes are selected as a subset of the first set in accordance with a performance criterion. For example, the second set may be selected such that the maximum magnitude of the cross-correlation function between all pairs of members of the second set, modulated by offset carriers, is below a threshold—e.g. is the smallest possible for a group of subsets at all frequencies of a set of offset frequencies. Selecting the second set this way may be used to minimize the value of cross-talk in a receiver during matched filter or correlation processing. At stage 1040, the second set of codes may be stored in a memory. The memory may be in the server system 130 or a transmitter 110 of FIG. 1, or another system. If the memory is in the server system 130, the second set of codes may be provided, at stage 1050, to one or more of the transmitters 110 for use in encoding positioning signals. The method for storage of the codes is typically based upon the specification of linear feedback shift registers; however, many alternatives exist, such as indices of a code set, relative delays between codes, and even a listing of each constituent element (e.g. bits or words) of the code sequences.

FIG. 11 illustrates a process 1100 for transmitting a positioning signal from transmitter, such as one of the transmitters 110 of FIG. 1, where the positioning signal is encoded at least in part using a code from a set of codes. At stage 1110, a code may be selected from the set of codes. For example, all members of the set may have a magnitude of their autocorrelation function (except at the peak) less than a predefined value. In addition, all members of the set may optimize a criterion, such as where the cross-correlation magnitude between set members at all offset frequencies within a set of offset frequencies is less a threshold value. The code may be selected in a transmitter or provided to the transmitter from another system, such as the server system 130 of FIG. 1.

At stage 1120, a positioning signal may be generated in a transmitter. At least a portion of the positioning signal may be encoded using the selected code. At stage 1130, the generated positioning signal may be transmitted from the transmitter and may then be received at one or more receivers. The receivers may have the code or the set of codes stored in a memory for use in demodulating and/or decoding the received positioning signal. In one embodiment, multiple positioning signals are sent from different transmitters to the receiver, where the different transmitters use the same or different offset frequencies.

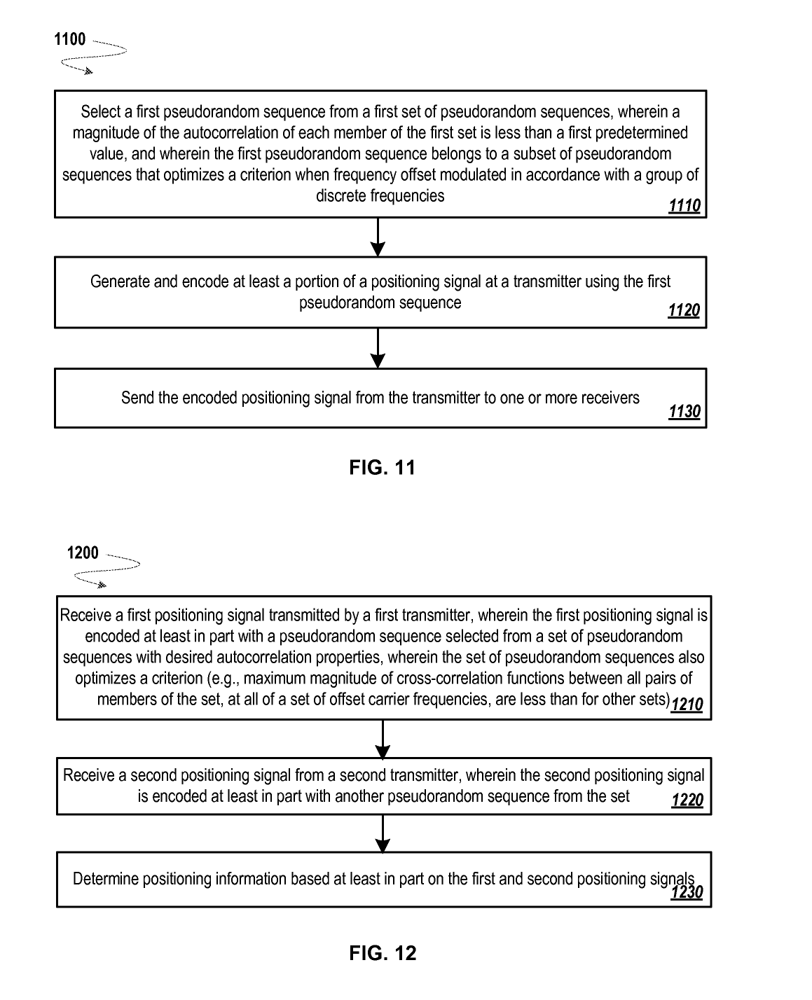

FIG. 12 illustrates a process 1200 for receiving encoded positioning signals at a receiver using FOM. At stage 1210, a first positioning signal is received at a receiver from a first transmitter. The first positioning signal is encoded at least in part using a code selected from a set of codes. By way of example, the set of codes have desired autocorrelation properties and optimize another performance criterion involving the relationship of the codes to one another and a set of offset carrier frequencies. For example, the criterion may include having magnitudes of cross-correlation functions between all pairs of members of the set be less than that of another set of codes at all of a plurality of offset frequencies. At stage 1220, a second positioning signal from a second transmitter is received at the receiver. The second positioning signal may be encoded with a second code chosen in a similar manner to that of the first positioning signal (e.g. chosen from the set of codes). At stage 1230, the received first positioning signal and the received second positioning signal may be processed at the receiver or elsewhere (e.g. a server system) to determine positioning information in a manner described elsewhere herein or in the incorporated references, or as is known by one of ordinary skill in the art.

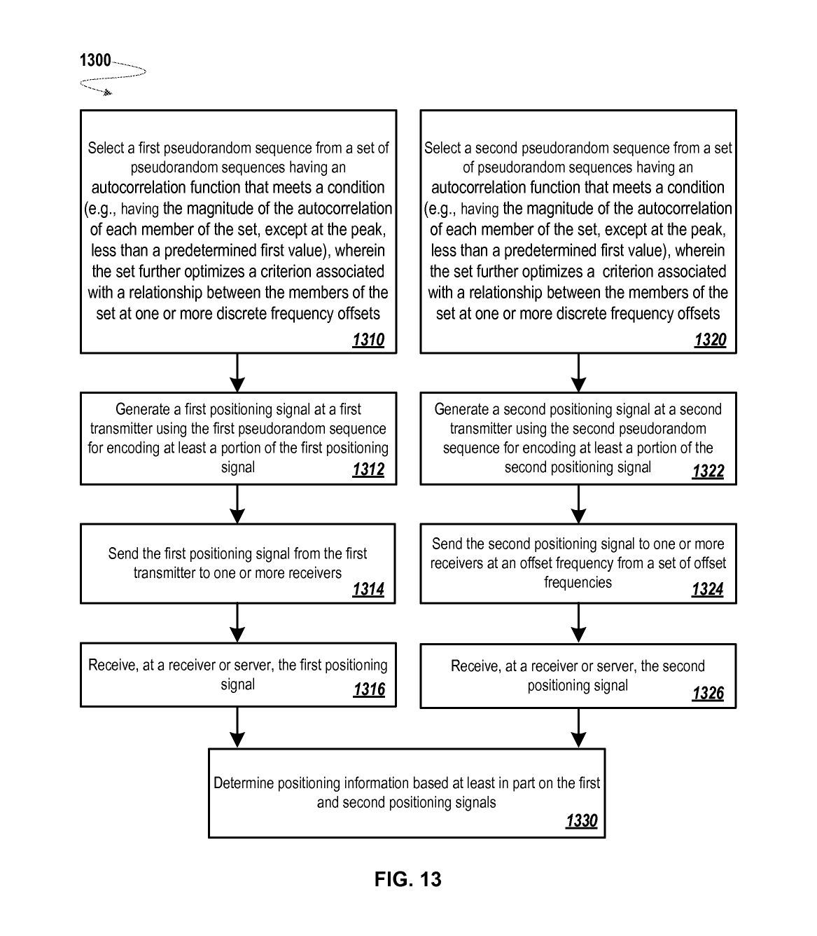

FIG. 13 illustrates a process 1300 for transmitting positioning signals in a positioning system using FOM. Each of the positioning signals is transmitted from a different transmitter of two or more transmitters. The process 1300 further relates to receiving and processing the positioning signals in order to determine positioning information. Stages 1310 through 1314 represent stages that are performed at a first transmitter, and stages 1320-1324 represent stages that are performed at a second transmitter. These stages may be implemented simultaneously in both transmitters such that the positioning signals from each transmitter are received at a receiver at times that differ mainly due to differences in the path lengths between transmitters and the receiver. At stages 1310 and 1320, a first code and a second code are selected from a set of codes, where members of the set of codes all have autocorrelation functions less than a predetermined value—e.g. a magnitude of the autocorrelation of each member of the set, except at the peak, less than a predetermined first value. The members of the set may further meet a performance criterion that specifies a relationship between all members of the set at all offset frequencies of a set of offset frequencies. For example, the criterion may specify a threshold condition that must be met by the maximum magnitude of the cross-correlation between pairs FOM modulated codes, where the offset frequencies may be within a specified range

The first and second codes may be selected well in advance of transmission of positioning signals, and may be generated at the server system 130 of FIG. 1 before being communicated to the first and second transmitters. Alternatively, the first and second codes may be generated in one or both of the first and second transmitters, and/or may be communicated between the first and second transmitters to coordinate which of the codes will be used by the first and second transmitters.

At stages 1312 and 1322, first and second positioning signals are generated at the first and second transmitters, where the first and second positioning signals are encoded at least in part using the corresponding first and second codes, respectively. At stages 1314 and 1324, the first and second positioning signals are transmitted from the first and second transmitters. In one embodiment, one of the signals is offset by an offset frequency from the set of offset frequencies. Both transmitted signals may be received at a receiver at stages 1316 and 1326. At stage 1330, positioning information is determined based at least in part on the first and second positioning signals. The positioning information may be determined using, for example, signal processing techniques as described herein and in the incorporated references, or that are known by one of ordinary skill in the art.

In a manner similar to the discussion respect to FIG. 6, the option to optimize a criterion in FIGS. 7-13 may be replaced by merely meeting a criterion. This may be done, for example, when the optimization is too laborious to compute or where some additional constraints may be placed upon the subset of codes.

### Additional Aspects

Functionality and operations disclosed herein may be embodied as one or more methods implemented, in whole or in part, by machine(s)—e.g. processor(s) or other suitable means—at one or more locations. Non-transitory machine-readable media embodying program instructions adapted to be executed to implement the method(s) are also contemplated. Execution of the program instructions by one or more processors cause the processors to carry out the method(s), including methods for selecting codes to be used in association with positioning signals generated at and transmitted from one or more transmitters.

Such method steps may: identify a set of codes (e.g. digital codes), wherein a magnitude of an autocorrelation function of each member of the set of codes, within a specified zonal region adjacent to a peak of the autocorrelation function, is equal to or less than a first prescribed value; identify a subset of codes, from among two or more subsets of codes in the set of codes, that optimizes a performance criterion, wherein the performance criterion is associated with a relationship between members within any subset of the two or more subsets.

In accordance with some aspects, the subset that optimizes the performance criterion minimizes a maximum magnitude of a cross-correlation between each pair of non-identical codes of that subset (e.g. as compared to the other subsets of the two or more subsets). In accordance with some aspects, the first prescribed value is equal to or less than one-half of the maximum magnitude of the cross-correlation. In accordance with some aspects, the first prescribed value is equal to or less than one-tenth of the maximum magnitude of the cross-correlation.

In accordance with some aspects, a set of frequency offset modulated (FOM) signals is generated, wherein each of the members of the set of FOM signals are generated by modulating each signal with a member of the set of codes, and further modulating each signal with a carrier whose frequency is chosen among a set of offsets relative to a base offset frequency.

In accordance with some aspects, the performance criterion includes the maximum magnitude of the cross-correlation between all pairs of FOM signals, where each pair has different codes and where frequency offsets associated with each pair are within a range.

In accordance with some aspects, the first prescribed value is equal to or less than one-half of the maximum magnitude of the cross-correlation between the FOM signals.

In accordance with some aspects, the first prescribed value is equal to or less than one-tenth of the maximum magnitude of the cross-correlation between said FOM signals.

Additional method steps may: identify a first code from the subset; encode at least a portion of a first positioning signal using the identified first code; and cause the first positioning signal to be sent from a first transmitter.

Additional method steps may: identify a second code from the subset; encode at least a portion of a second positioning signal using the identified second code; and cause the second positioning signal to be sent from a second transmitter.

In accordance with some aspects, the second positioning signal is transmitted at an offset frequency relative to the first positioning signal.

In accordance with some aspects, the first code is selected at the first transmitter, and where the second code is selected at the second transmitter. In accordance with some aspects, the first code and the second code are selected at a remote server system.

Additional method steps may: cause a receiver to determine positioning information using the first positioning signal and the second positioning signal.

Additional method steps may include: receive, at the receiver, the first and second positioning signals; and determine, based at least in part on the first and second positioning signals, information associated with a location of the receiver.

In accordance with some aspects, the information associated with the location of the receiver is further determined in part based on one or more received global navigation satellite system (GNSS) signals.

In accordance with some aspects, each subset of the plurality of subsets contain an equal number of codes. In accordance with some aspects, each subset of the plurality of subsets include respective numbers of codes that are within a range of sizes.

Additional method steps may include: receive, at a first processor, data associated with the first and second positioning signals; and determine, based at least in part on the data associated with the first and second positioning signals, an estimated location of the receiver.

In accordance with some aspects, the performance criterion is optimized when the maximum magnitude of the cross-correlation function between members of the subset, when modulated at each of one or more offset frequencies, is less than the maximum cross-correlation magnitude of other subsets in the set.

In accordance with some aspects, the subset optimizes the performance criterion when a cross-correlation condition associated with the subset codes is preferred over the cross-correlation condition associated with another subset of codes.

In accordance with some aspects, the subset optimizes the performance criterion when a cross-correlation magnitude associated with the subset of codes is less than a cross-correlation magnitude associated with the other subset of codes.

In accordance with some aspects, the subset optimizes the performance criterion when a result achieved by codes within the subset in relation to the performance criterion is preferred over another result achieved by codes within another subset in relation to the performance criterion.

In accordance with some aspects, the performance criterion is associated with a relationship between all pairs of signals that are modulated with different members within the subset and further modulated with carrier frequencies that are chosen among a set of offsets relative to a base frequency. In accordance with some aspects, the relationship is the maximum cross-correlation magnitude over all the pairs of signals.

Other method steps may include: identify a first code from a subset of codes within a set of codes, wherein a magnitude of an autocorrelation function of each member of the set of codes, within a zonal region adjacent to a peak of the autocorrelation function, meets a threshold condition, and wherein the subset optimizes a performance criterion between its members compared to other subsets of the set.

In accordance with some aspects, the subset that optimizes the performance criterion minimizes a maximum magnitude of a cross-correlation between pairs of members of that subset. In accordance with some aspects, the subset that optimizes the performance criterion minimizes a maximum magnitude of a cross-correlation between each pair of non-identical codes of that subset, a set of frequency offset modulated (FOM) signals is generated, the members of the set of FOM signals are generated by modulating a carrier frequency signal with a member of the set of codes, an offset frequency for the FOM signals is chosen among a predefined set of offset frequencies, and the performance criterion includes a minimization of the maximum magnitude of the cross-correlation between all pairs of FOM signals, where each pair has different codes and wherein frequency offsets associated with each pair are within a specified range.

Additional method steps may: identify (e.g. select) a first code from the subset; cause at least a portion of a first positioning signal to be encoded using the identified first code (e.g. applies the code to the signal); cause the first positioning signal to be sent from a first transmitter; identify (e.g. select) a second code from the subset; cause at least a portion of a second positioning signal to be encoded using the identified second code (e.g. applies the code to the signal); and cause the second positioning signal to be sent from a second transmitter, where the second positioning signal is transmitted at an offset frequency relative to the first positioning signal, and where the subset optimizes the performance criterion when a cross-correlation condition associated with the subset codes is preferred over the cross-correlation condition associated with another subset of codes.

Other method steps may: receive a first positioning signal that is encoded at least in part with a first code selected from a subset of a set of codes, wherein the set of codes are characterized by having a magnitude of an autocorrelation function of each member of the set, within a specified zonal region adjacent to a peak of the autocorrelation function, equal to or less than a first prescribed value, and wherein the subset is selected from among a group of subsets to optimize a performance criterion in comparison to the other subsets of the group, wherein the performance criterion is associated with a relationship between members of any subset; receive a second positioning signal that is encoded at least in part with a second code from the subset of codes; and determine, based at least in part on the first and second positioning signals, positioning information associated with a receiver.

In accordance with some aspects, the second positioning signal is sent at an offset frequency relative to the first positioning signal, wherein the offset frequency is selected from a set of one or more predefined offset frequencies. In accordance with some aspects, each subset of the group of subsets has a number of codes that falls within a specified range of numbers. In accordance with some aspects, the positioning information is determined further based at least in part on a received GNSS signal. In accordance with some aspects, the subset that the optimizes the performance criterion minimizes a magnitude of a cross-correlation between pairs of members of that subset.

In accordance with some aspects, a set of frequency offset modulated (FOM) signals is generated, where the members of the set of FOM signals are generated by modulating a carrier frequency signal with a member of the set of codes, where an offset frequency for the FOM signals is chosen among a predefined set of offset frequencies, where the performance criterion includes a minimization of the maximum magnitude of the cross-correlation between all pairs of FOM signals, where each pair has different codes and wherein frequency offsets associated with each pair are within a specified range, and where the subset optimizes the performance criterion when a cross-correlation condition associated with the subset codes is preferred over the cross-correlation condition associated with another subset of codes.

Additional method steps may: identify a first code from the subset; encode at least a portion of a first positioning signal using the identified first code; cause the first positioning signal to be sent from a first transmitter; identify a second code from the subset; encode at least a portion of a second positioning signal using the identified second code; and cause the second positioning signal to be sent from a second transmitter, where the subset that optimizes the performance criterion minimizes a maximum magnitude of cross-correlations over all pairs of non-identical codes of that subset.

The requirements discussed above in this Section (Additional Aspects) to optimize a criterion may be replaced by merely meeting a criterion. Again, this may be done, for example, when the optimization is too laborious to compute or where some additional constraints may be placed upon the subset of codes.

Other method steps may: encode at least a portion of a first positioning signal using a first code; encode at least a portion of a second positioning signal using a second code; cause the encoded first positioning signal to be sent from a first transmitter; and cause the encoded second positioning signal to be sent from the second transmitter, where the first and second codes are included among members of a first set of codes that optimize a performance criterion associated with a relationship between the members of the first set of codes, and where the first and second codes are included among members of a second set of codes characterized by having a magnitude of an autocorrelation function within a zonal region adjacent to a peak of the autocorrelation function that is equal to or less than a first prescribed value. In accordance with some aspects, the second positioning signal is sent from the second transmitter at an offset frequency relative to the first positioning signal. In accordance with other aspects, the offset frequency is selected from a predefined set of offset frequencies.

Although certain embodiments describe subsets of codes from a set of codes, it is contemplated that codes may belong to two sets that are not necessarily related to each other beyond including one or more shared codes. Additionally, it is contemplated that the auto and cross correlation analyses may occur in a different order (e.g. choosing a set of codes with good cross-correlation properties and then optimizing to get a subset of those codes with good auto-correlation properties). Also, it is contemplated that the auto and cross correlation analyses may occur independent of one another, and codes are selected from an intersection of codes that are determined from each analysis.

Systems may include any or all of: one or more receivers at which positioning information is received and used to compute a position of the respective receiver; one or more servers at which positioning information is received and used to compute a position of a receiver; both receivers and servers; or other components.

An output from one system may cause another system to perform a method even if intervening steps occur between the output and performance of the method.

The illustrative methods described herein may be implemented, performed, or otherwise controlled by suitable hardware known or later-developed by one of ordinary skill in the art, or by firmware or software executed by processor(s), or any combination of hardware, software and firmware. Software may be downloadable and non-downloadable at a particular system.

Systems on which methods described herein are performed may include one or more means that implement those methods. For example, such means may include processor(s) or other hardware that, when executing instructions (e.g. embodied in software or firmware), perform any method step disclosed herein. A processor may include, or be included within, a computer or computing device, a controller, an integrated circuit, a “chip”, a system on a chip, a server, other programmable logic devices, other circuitry, or any combination thereof.

“Memory” may be accessible by a machine (e.g. a processor), such that the machine can read/write information from/to the memory. Memory may be integral with or separate from the machine. Memory may include a non-transitory machine-readable medium having machine-readable program code (e.g. instructions) embodied therein that is adapted to be executed to implement each of the methods and method steps disclosed herein. Memory may include any available storage media, including removable, non-removable, volatile, and non-volatile media—e.g. integrated circuit media, magnetic storage media, optical storage media, or any other computer data storage media. As used herein, machine-readable media includes all forms of machine-readable media except to the extent that such media is deemed to be non-statutory (e.g. transitory propagating signals).

Application programs may carry out aspects by receiving, converting, processing, storing, retrieving, transferring and/or exporting data, which may be stored in a hierarchical, network, relational, non-relational, object-oriented, or other data source. A data source may be a single storage device or realized by multiple (e.g. distributed) storage devices.

All of the information disclosed herein may be represented by data, and that data may be transmitted over any communication pathway using any protocol, stored on a data source, and processed by a processor. For example, transmission of data may be carried out using a variety of wires, cables, radio signals and infrared light beams, and an even greater variety of connectors, plugs and protocols even if not shown or explicitly described. Systems described herein may exchange information with each other (and with other systems that are not described) using any known or later-developed communication technology, including WiFi, Bluetooth, NFC and other communication network technologies. Carrier waves may be used to transfer data and instructions through electronic, optical, air, electromagnetic, RF, or other signaling media over a network using network transfer protocols. Data, instructions, commands, information, signals, bits, symbols, and chips disclosed herein may be represented by voltages, currents, electromagnetic waves, magnetic fields or particles, optical fields or particles, or any combination thereof.

Different systems disclosed herein may be geographically dispersed from one another in different regions (e.g. cities, countries), such that different method steps are performed in different regions and by different systems.

Features in system figures that are illustrated as rectangles may refer to hardware, firmware or software, each of which may comprise a component of a device. It is noted that lines linking two such features may be illustrative of data transfer between those features. Such transfer may occur directly between those features or through intermediate features even if not illustrated. Where no line connects two features, transfer of data between those features is contemplated unless otherwise stated. Thus, such lines are provided to illustrate certain aspects, but should not be interpreted as limiting. The words comprise, comprising, include, including and the like are to be construed in an inclusive sense (i.e not limited to) as opposed to an exclusive sense (i.e consisting only of). Words using the singular or plural number also include the plural or singular number, respectively. The words or or and, as used in the Detailed Description, cover any of the items and all of the items in a list. The words some, any and at least one refer to one or more. The term may is used herein to indicate an example, not a requirement—e.g. a thing that may perform an operation or may have a characteristic need not perform that operation or have that characteristic in each embodiment, but that thing performs that operation or has that characteristic in at least one embodiment. This disclosure is not intended to be limited to the aspects shown herein but is to be accorded the widest scope understood by a skilled artisan, including equivalents.

It is noted that the term “GPS” may refer to any Global Navigation Satellite Systems (GNSS), such as GLONASS, Galileo, and Compass/Beidou.

Receiver(s) may be in the form of or included in a cellular or smart phone, a tablet device, a PDA, a notebook, a digital camera, an asset tracking tag, an ankle bracelet or other computing device.

Certain aspects disclosed herein relate to a positioning system that estimates the positions of things—e.g. where the position is represented in terms of: latitude, longitude and/or altitude coordinates; x, y and/or z coordinates; angular coordinates; or other representations known by one of skill in the art. Positioning systems use various techniques to estimate the position of a thing (e.g. a receiver), including trilateration, which is the process of using geometry to estimate the position using distances traveled by different “ranging” signals that are received by the receiver from different beacons (e.g. transmitters, satellites, antennas). If the transmission time and reception time of a ranging signal are known, then the difference between those times multiplied by speed of light would provide an estimate of the distance traveled by that ranging signal. These estimates of distance are often referred to as “range” measurements. When errors in the measured time(s) are present (sometimes called time or range “bias”), a “range” measurement is typically referred to as a “pseudorange” measurement. Thus, a “pseudorange” measurement is a type of “range” measurement. Positioning systems and methods that estimate a position of a receiver based on signaling from beacons (e.g. transmitters and/or satellites) are described in co-assigned U.S. Pat. No. 8,130,141, issued Mar. 6, 2012, and U.S. patent application Ser. No. 13/296,067, filed Nov. 14, 2011, which are incorporated herein in their entirety and for all purposes, except where their content conflicts with the content of this disclosure.

Performing the operations disclosed herein on a multiplicity of signals from a multiplicity of beacons, whose locations are accurately known, allows determination of the receiver's location via trilateration algorithms. For example, in the system 100 of FIG. 1, three or more transmitters 110 may send uniquely encoded signals to the receiver 120, which may then estimate the distance to each of the transmitters 110, and triangulate a position from the estimated distances.

The disclosure is not intended to be limited to the aspects shown herein but is to be accorded the widest scope understood by a skilled artisan, including equivalent systems and methods. The protection afforded the present invention should only be limited in accordance with the following claims.

### RELATED APPLICATION(S)

This application relates to U.S. patent application Ser. No. 14/011,277, filed Aug. 27, 2013, entitled METHODS AND APPARATUS FOR PSEUDO-RANDOM CODING IN A WIDE AREA POSITIONING SYSTEM (WAPS), the content of which is hereby incorporated by reference herein in its entirety.

1. A system for selecting codes to be used within positioning signals sent from one or more transmitters, the system comprising at least one processor that:
identifies a set of codes, wherein a magnitude of an autocorrelation function of each member of the set of codes, within a specified zonal region adjacent to a peak of the autocorrelation function, is equal to or less than a first prescribed value; and
identifies a subset of codes, from among two or more subsets of codes in the set of codes, that optimizes a performance criterion, wherein the performance criterion is associated with a relationship between members within the subset.

2. The system of claim 1, wherein the subset that optimizes the performance criterion minimizes a maximum magnitude of a cross-correlation between all pairs of non-identical codes of that subset as compared to the other subsets of the two or more subsets.

3. The system of claim 2, wherein the first prescribed value is equal to or less than one-half of the maximum magnitude of the cross-correlation.

4. The system of claim 2, wherein said first prescribed value is equal to or less than one-tenth of the maximum magnitude of the cross-correlation.

5. The system of claim 1, wherein a set of frequency offset modulated (FOM) signals is generated, wherein each of the members of the set of FOM signals are generated by modulating each signal with a member of the set of codes, and further modulating each signal with a carrier whose frequency is chosen among a set of offsets relative to a base offset frequency.

6. The system of claim 5, wherein the performance criterion includes a minimization of the maximum magnitude of the cross-correlation between all pairs of FOM signals, wherein each pair has different codes and wherein frequency offsets associated with each pair are within a specified range.

7. The system of claim 6, wherein the first prescribed value is equal to or less than one-half of the maximum magnitude of the cross-correlation between the FOM signals.

8. The system of claim 6, wherein the first prescribed value is equal to or less than one-tenth of the maximum magnitude of the cross-correlation between said FOM signals.

9. The system of claim 1, wherein the at least one processor:
selects a first code from the subset;
causes at least a portion of a first positioning signal to be encoded using the identified first code; and
causes the first positioning signal to be transmitted by a first transmitter.

10. The system of claim 9, wherein the at least one processor:
selects a second code from the subset;
causes at least a portion of a second positioning signal to be encoded using the identified second code; and
causes the second positioning signal to be transmitted from a second transmitter.

11. The system of claim 10, wherein the second positioning signal is transmitted at an offset frequency relative to the first positioning signal.

12. The system of claim 10, wherein the first code is selected at the first transmitter, and wherein the second code is selected at the second transmitter.

13. The system of claim 10, wherein the first code and the second code are selected at a remote server system.

14. The system of claim 1, wherein each subset of the two or more subsets contain an equal number of codes.

15. The system of claim 1, wherein each subset of the two or more subsets include respective numbers of codes that are within a range of sizes.

16. The system of claim 10, wherein the at least one processor:
receives, at a first processor, data associated with the first and second positioning signals; and
determines, based at least in part on the data associated with the first and second positioning signals, an estimated location of the receiver.

17. The system of claim 1, wherein the performance criterion is associated with a relationship between all pairs of signals that are modulated with different members within the subset and further modulated with carrier frequencies that are chosen among a set of offsets relative to a base frequency.

18. The system of claim 17 wherein the relationship is the maximum cross-correlation magnitude over all the pairs of signals.

19. The system of claim 1, wherein the subset optimizes the performance criterion when a cross-correlation condition associated with the subset's codes is preferred over the cross-correlation condition associated with the other subsets of the two or more subsets.

20. The system of claim 18, wherein the subset optimizes the performance criterion when a cross-correlation magnitude associated with the subset of codes is less than a cross-correlation magnitude associated with the other subsets.

21. The system of claim 1, wherein the subset optimizes the performance criterion when a result achieved by codes within the subset in relation to the performance criterion is preferred over other results achieved by codes within the other subsets in relation to the performance criterion.

22. The system of claim 10, wherein the at least one processor:
causes a receiver to determine positioning information using the first positioning signal and the second positioning signal.

23. The system of claim 22, wherein the at least one processor includes a processor at the receiver, and wherein the at least one processor:
Determines information associated with a location of the receiver based at least in part on the first and second positioning signals that are received at the receiver.

24. The system of claim 23, wherein the information associated with the location of the receiver is further determined in part based on one or more received global navigation satellite system (GNSS) signals.
